(19) United States
(12) Patent Application Publication
(10) Pub. No.: US 2014/0360011 A1
(43) Pub. Date: Dec. 11, 2014

(54) DEVICE FOR INSTALLING AND UNINSTALLING A VEHICLE BATTERY

(71) Applicant: RENAULT S.A.S., Boulogne-Billancourt (FR)

(72) Inventors: Gilles Mulato, Chatillon (FR); Florent Jardel, Saint-Ouen (FR); Alain Bachir, Saint Germain de la Grange (FR)

(73) Assignee: RENAULT S.A.S., Boulogne-Billancourt (FR)

(21) Appl. No.: 14/371,205

(22) PCT Filed: Dec. 21, 2012
(86) PCT No.: PCT/FR2012/053046

§ 371 Date: Aug. 15, 2014

(30) Foreign Application Priority Data
Jan. 9, 2012 (FR) 12 50219

(51) Int. Cl. B60L 11/18; B60K 1/04; B60S 5/06

(52) U.S. Cl. CPC B60L 11/1822; B60S 5/06; B60K 1/04; B60K 2001/0472
USPC 29/729; 29/762

(57) ABSTRACT

A device for installing and uninstalling a battery on an underside of an electric or hybrid vehicle, the underside of the vehicle lying within a first substantially horizontal plane. The device includes a lift table that vertically moves an engaging member capable of engaging with the underside of the vehicle. The engaging member is moved by the table to mechanically engage with the underside of the vehicle, the underside of the member then being arranged in a second substantially horizontal plane in a state in which, due to a relative inclination between the first and second plane, the engaging member cannot engage with the underside of the vehicle. The lift table is raised using at least two cables, the elasticity of which makes it possible to compensate for the relative inclination of the two planes to enable the engaging member to engage with the underside of the vehicle.

### TECHNICAL FIELD OF THE INVENTION

The invention concerns the field of exchanging a power supply battery for an electric traction motor of a vehicle of the fully electric or hybrid type.

The object of the invention is more particularly a device for installing and uninstalling such a battery on a vehicle.

### STATE OF THE ART

Certain motor vehicles, such as electric or hybrid vehicles, comprise a power supply container for an electric drive motor, such as an electricity-supply battery. In the description which follows, the term “battery” will be used for simplicity to designate, in the widest sense, any electricity-supply container for an electric drive motor of a vehicle. It may be useful to exchange this battery, when its energy level is low, for a new charged battery. This can be done in an exchange station, such as for example a station similar to a service station for filling the tanks associated with internal combustion engines.

Document US 2010/145717 discloses an exchange station for electricity-supply batteries for an electric drive motor of an electric vehicle and a method for performing such an exchange. The exchange station described comprises a lift table carrying an element for locking and unlocking the battery on the vehicle.

One difficulty in establishing such a battery exchange concept is the fact that there are a multitude of motor vehicles which may comprise batteries of different types which are fixed to the motor vehicle in different ways. It is not economically feasible to multiply the systems for installing and uninstalling these different types of batteries, nor to establish a manual solution because of the cost and weight of the batteries. The solution described in document US 2010/145717 does not satisfactorily solve this problem of flexibility of the battery exchange solution, in particular because of a lack of robustness.

No solutions known at present solve the problem of flexibility while presenting a simple design, with limited space requirement and reasonable cost.

### OBJECT OF THE INVENTION

To allow easy development of battery exchange solutions, it is necessary to make the functioning of these solutions reliable, simple, robust, flexible and universal, while limiting their cost and space requirement.

The object of the present invention is to provide a solution for exchanging a supply battery of an electric traction motor of a vehicle of the fully electric or hybrid type, which solves these problems.

Therefore a device is proposed for installing and uninstalling a battery on the underside of an electric or hybrid vehicle, the underside of the vehicle lying in a first substantially horizontal plane, the device comprising a lift table which vertically moves an engaging member able to interact with the underside of the vehicle. The engaging member is brought by the lift table into mechanical contact with the underside of the vehicle, the top of the member then lying in a second substantially horizontal plane in a state which does not allow said member to interact with the underside of the vehicle because of a relative inclination between the first and second planes. The lift table is raised by means of at least two cables, the elasticity of which allows compensation for the relative inclination of the two planes in order to enable the member to interact with the underside of the vehicle.

The elasticity of the cables may allow compensation for the relative inclination of the two planes within the limit of deformability of said cables.

The cables may be arranged symmetrically on either side of the lift table and be driven by the same motor and/or via pulleys.

The device may also comprise a position correction element allowing the vehicle to be placed in the first substantially horizontal plane.

As the engaging member comprises an actuator element for a mechanism for locking and/or unlocking the battery on the underside of the vehicle, wherein the mechanism comprises a plurality of latches, and the elasticity of the cables may allow compensation for the relative inclination between the planes in order to enable the actuation of the latches.

One of the main advantages of the invention is that it is robust, flexible and universal, since the engaging member can easily be adapted to the type of vehicle while retaining a simple design, with limited space requirement and reasonable cost.

### BRIEF DESCRIPTION OF THE DRAWINGS

Other advantages and characteristics will arise more clearly from the description below of particular embodiments of the invention, given as non-limitative examples and shown in the attached drawings in which:

FIGS. 1 and 2 are perspective views of a first embodiment of an installing and uninstalling device, according to the second aspect of the invention;

FIG. 3 is a side view of a second embodiment of an installing and uninstalling device, according to the second aspect of the invention;

FIG. 4 is a diagrammatic view from above of an example of an exchange station according to the third aspect of the invention;

FIG. 5 is a side view of the first embodiment in a situation of cooperation and mechanical contact of the engaging member.

### DESCRIPTION OF PREFERRED EMBODIMENTS OF THE INVENTION

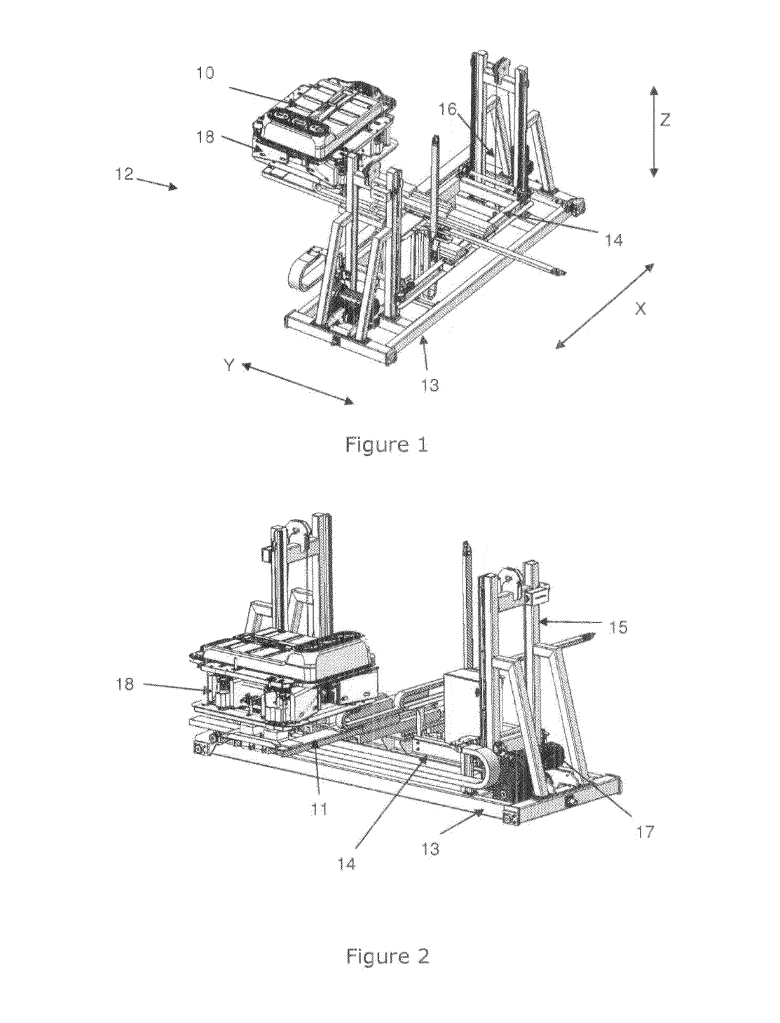

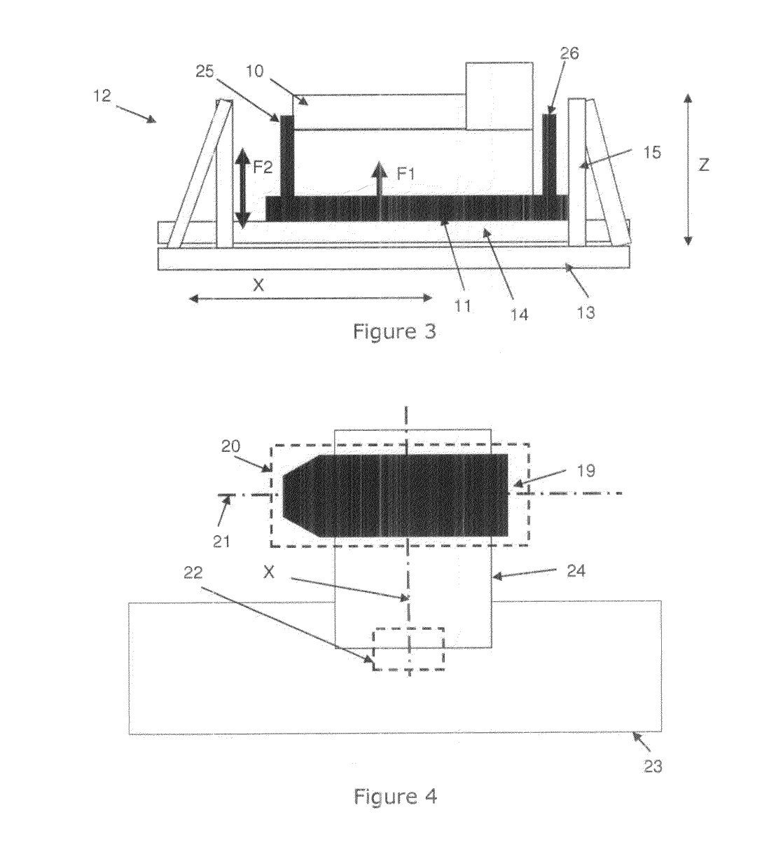

FIGS. 1 and 2 show a first embodiment of a device for installing and uninstalling a supply battery 10 on a motor vehicle with fully electric or hybrid traction. FIG. 3 illustrates a second embodiment, simplified in relation to the first, as will be understood below. The common elements in the two embodiments carry identical references on the figures. Each of these devices is designed to allow the installing and uninstalling of a battery 10 in a housing cell on the underside of the vehicle.

In FIGS. 1 and 2, the device for installing/uninstalling batteries 10 comprises to this end a lift table 11 which is intended indirectly for locking and unlocking a battery 10 in relation to the housing cell of the vehicle, and for moving the battery at least vertically when it is in the unlocked state in a vertical direction marked Z. To be able to perform the operations of installation or removal of the battery in or from the housing cell and the operations of locking and unlocking the battery once installed, it is necessary for the lift table 11 to be correctly positioned in relation to the vehicle, in particular in relation to its housing cell, and for the vehicle to have a suitable position in relation to the lift table.

The lift table 11 therefore carries an engaging member which is able to interact with the underside of the vehicle. The engaging member can comprise an element for relative positioning of the lift table 11 in relation to the vehicle and/or for correction of the vehicle position. This positioning element may be intended to compensate for horizontal offsets between the table 11 and the vehicle, and optionally to cause a raising of the vehicle by lifting the table 11 to a predetermined height in order to compensate for height differences between the different types of existing vehicles. The position correction element may consist of a carrier with several contact points with the vehicle, wherein all the points of the carrier can be brought into contact with the vehicle by a raising of the vehicle at the same time as or after that corresponding to the relative positioning of the vehicle/table. These positioning and/or position correction elements may be associated with the table by a removable assembly, allowing removal of said elements in relation to the lift table as required.

In addition or instead, the engaging member may comprise a support element for the battery 10 during its storage and/or electric recharging, thus ensuring the support of the battery when unloaded from the table 11 of the installing and uninstalling device. Such a support element, such as a pallet or of a type which may for example be known as a “slide”, can in particular be intended to facilitate handling and storage of the battery outside the installing/uninstalling device.

Therefore the mobility of the lift table 11 in the vertical direction Z, as well as allowing it to fulfill its function of lifting the batteries, also allows the engaging member described above to interact with the underside of the vehicle, for example in the form of approach and/or placing of the engaging member against the vehicle so that the constituent elements thereof (positioning and/or position correction element and/or battery support element during storage and/or electric charging of the battery) can fulfill their functions.

The installing and uninstalling device comprises a trolley 12 on which the lift table 11 is mounted and which is configured so as to move the assembly consisting of the lift table 11 and the engaging member in at least one substantially horizontal movement direction. To move this assembly, a possibility may be provided for horizontal translation of the trolley 12 in the first movement direction X and where applicable a possibility of horizontal movement of the lift table 11 in relation to the trolley 12 in a second movement direction Y. In other words, the trolley 12 in the latter case is configured so as to move the lift table 11 relative to itself in the second direction Y. As a variant however, it is possible for the trolley 12 to be designed so as to move in both directions X and Y which are for example perpendicular to each other. The first and second embodiments thus provide movement of the trolley 12 in the first direction X, while only the first embodiment provides horizontal movement of the table 11 in the second direction Y, for example using the movement of the table relative to the trolley 12 on which it is mounted.

As the lift table 11 can thus be moved horizontally by action of the trolley 12, it can advantageously change position from the area of installing/uninstalling batteries on vehicles, in order for example to be able to participate in other operations necessary for managing the battery exchange, at different working heights, such as operations of battery cleaning and/or operations of installation and removal of the batteries in and from the cells for storage and/or electric recharging.

Also, the engaging member carried by the lift table 11 may optionally comprise an actuator element 18 for a mechanism for locking a battery on the vehicle. Such a locking mechanism is thus able to shift between a locked state which spatially immobilizes the battery, with which it cooperates in a mounted position, inside the housing cell of the vehicle, and an unlocked state which spatially releases the battery from its mounted position. The actuator element can thus be designed such that a suitable maneuver of the latter controls passage of the locking mechanism from one state to the other, this maneuver taking place via the underside of the vehicle for example.

As an example showing the advantage of its rapidity and ease of implementation, the locking mechanism fitted to a vehicle can be configured such that, for operation, the mechanism must be force-operated in order to achieve its release, then at least one latch (for example, four in number) must be rotated (for example through 90°) in order to obtain the locking and/or unlocking of the mechanism. It is also possible that the actuator element 18 is flexible in the sense that it can be adjusted or changed in order to adapt to the different types of locking mechanism which may be fitted to different vehicle types. For this, the element 18 can advantageously comprise a standard interface and a number of standard and modular components, in order to obtain an element 18 suitable for intervention on all types of battery and all motor vehicles. Such an actuator element 18 is also known as a “toolbox”, as described for example in the application published under number FR2952334.

The horizontal movement of the table 11 by action of the trolley 12 therefore advantageously allows a possible change of position of the actuator element 18 from the zone of installing/uninstalling batteries on vehicles, in order for example to be able to use this element 18 as a substitute for the support element previously described, or even to use this element 18 for installing and/or removing a battery into or from a storage cell of a structure for storage and/or recharging, in the case where the cell is itself advantageously fitted with a locking mechanism corresponding to that of the housing cell of the vehicle.

As FIGS. 1 and 2 show, one possible design—which is in no way limitative—is for the trolley 12 to comprise a rolling element 13 intended to ensure a global translation of the trolley 12 (and hence of the assembly of lift table 11/engaging member) in at least the movement direction X, or also in the movement direction Y, which is not however the case on FIGS. 1 and 2. The movement of this rolling element 13 may be obtained using on-board propulsion means or using external traction means (for example cables, or a rack system).

The trolley 12 may also comprise a lifting platform 14 which is vertically movable in the Z direction and linked to the rolling element 13 by any means of relative lifting between these two parts. For example the vertical movement in direction Z of the platform 14 relative to the rolling element 13 can be obtained by a pair of lift forks 15 offset in direction X, each of the forks being actuated in vertical movement by at least one cable 16, the extension of which is controlled for example by a corresponding motor 17 mounted on the rolling element 13. Advantageously, as illustrated by the embodiment in FIG. 5 which allows the installing and uninstalling of a battery 10′ with dimensions substantially different from those of the battery 10, the relative elasticity of the lifting cables 16 and 16′ allows two planes to be matched, i.e. brought parallel, these planes being the substantially horizontal plane of the vehicle (this plane having been established after correction of the vehicle position as described above) and the substantially horizontal plane of the battery (this plane having been established after positioning of the battery on the lift table 11 as described above). Cables 16 and 16′, which are separated from each other and for example arranged symmetrically to each other on either side of the lift table 11, for example in direction X, are both driven by the same motor 17 via a pulley of axis 27 for cable 16′ and via two pulleys of axes 28 and 29 for cable 16. The absence of parallelism between the two planes, although substantially horizontal, is characterized by a slight angular difference ΔX around rotation axis X and by a slight angular difference ΔY around rotation axis Y. The elasticity of the lifting cables 16 and 16′ allows continued slight lifting of one side of the platform 14, for example the side lifted by cable 16′ on the example of FIG. 5, while the other side of said platform 14 is already blocked by the underside of the vehicle, for example the side lifted by cable 16 on the example in FIG. 5. In the present exemplary embodiment, it is the latch parts arranged on the side of the battery 10′ which come into mechanical contact with their complementary parts arranged on the side of the vehicle. It must be understood that the elasticity of the lifting cables 16 and 16′ allows continued slight lifting of the platform 14 on one side or the other within the limit of deformability of these cables, and that any cable—even made of steel—is slightly elastic. Thus the platform 14 is inclined when the side lifted by the cable 16′ continues to rise while the other side is blocked: the platform pivots about the axes X and Y so as to compensate for the differences ΔX and ΔY, wherein FIG. 5 illustrates the compensation for the difference ΔY. It should also be noted that, although it is essentially the substantially horizontal plane of the battery which is inclined, the substantially horizontal plane of the vehicle is also inclined but to a far lesser extent.

The lift table 11 is mounted on the lifting platform 14 by a linking means which may include a means of relative vertical movement between the lift table 11 and the lifting platform 14, and/or a means of relative horizontal movement between the lift table 11 and the platform 14 along the direction Y, which is not the case in the first embodiment. This latter eventuality is advantageously provided in the case where the rolling element 13 is not mounted movably in the direction Y. Secondly the means of relative vertical movement between table 11 and platform 14 has the advantage of giving a vertical global movement to the table 11 in relation to the rolling element 13 which is telescopic, i.e. with an optional first vertical component (see arrow F1 in FIG. 3) consisting of a relative movement between table 11 and platform 14, and an optional second vertical component (see arrow F2 in FIG. 3) consisting of a relative movement between platform 14 and rolling element 13. This is particularly advantageous in the case where the trolley is arranged in a pit provided in the ground, in order to reduce the depth of this pit as far as possible.

The horizontal movement of the table 11 in the Y direction is itself useful for example in the case where the table 11 participates in the operations of installation and removal of batteries into and from the structure for storage and/or electric recharging, allowing this structure to be installed remotely in relation to the trajectory of the trolley 12 in the direction X. The possibility of horizontal movement in direction Y of table 11 in relation to the platform 14 may be replaced by or combined with a possibility of relative movement in direction Y of the platform 14 in relation to the rolling element 13.

As indicated above, the embodiment of FIG. 3 is a simplification of that of FIGS. 1 and 2 in the sense that, in relation to the latter, the trolley 12 in FIG. 3 is not intended to provide a horizontal movement of table 11 in direction Y but only in direction X. Thus no movement is provided in direction Y of the rolling element 13, nor any movement in direction Y of platform 14 relative to the rolling element 13, nor any movement in direction Y of the table 11 in relation to the platform 14.

In a manner not shown, each installing/uninstalling device of the two embodiments can comprise at least two independent lift tables 11 arranged offset in direction Y. As a variant, it is possible to provide that the trolley 12 is configured so as to provoke a rotation of the single lift table 11 around a vertical pivot axis.

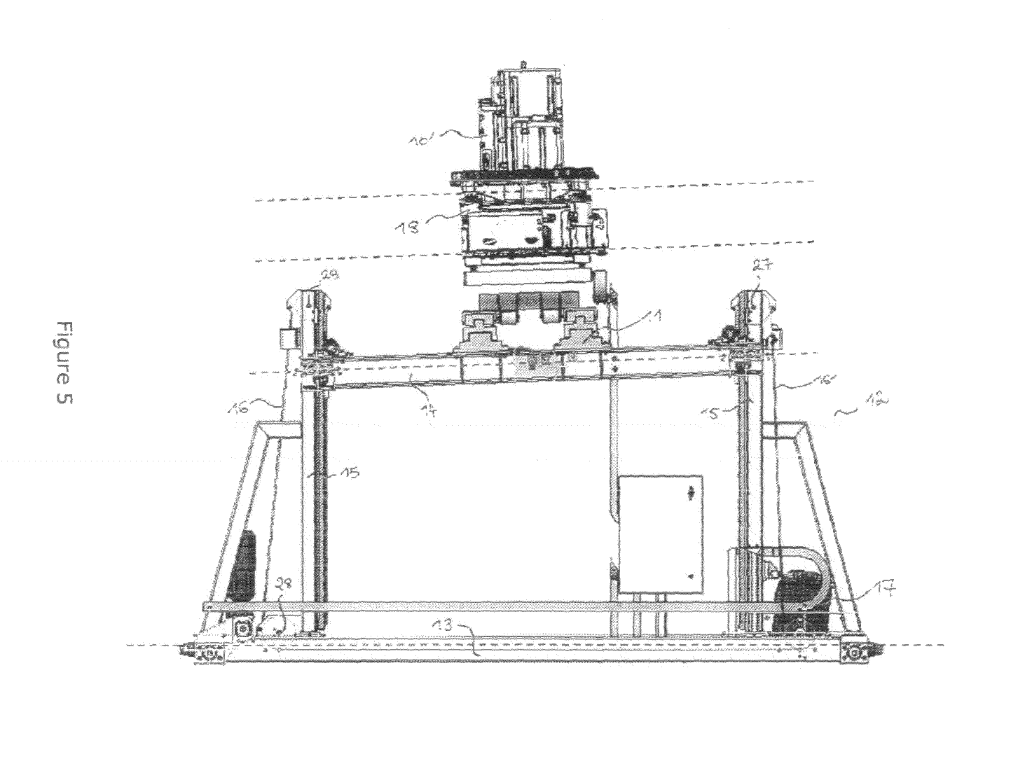

An installing and uninstalling device as mentioned above may therefore be used in operation of a battery exchange station for an electric or hybrid motor vehicle. The installation of an example of such a station is shown diagrammatically in a top view in FIG. 4. To allow access and evacuation of vehicles 19 to and from the actual installing and uninstalling zone 20, the station may also comprise a track 21 along which vehicles 19 are intended to travel. In a particular and non-exclusive variant as shown in FIG. 4, the installing and uninstalling device may be established so as to have an orientation such that the trolley 12 moves in a movement direction X substantially perpendicular to the direction of travel of the vehicles 19 along the track 21. However the movement direction X of the trolley 12 may also be oriented parallel to the track 19.

This station can be configured such that the assembly (table 11 and engagement member) moves from or to a transfer zone 22 in which a removed battery is transferred from the installing and uninstalling device to a handling device which is separate from the installing and uninstalling device, or vice versa. This handling device, which may have any design suitable for its function, is able to move the battery between the transfer zone 22 and a storage and/or charging zone 23 for batteries. In this case it is possible to arrange the installing and uninstalling device in a pit 24 provided in the ground, the transfer zone 22 then being provided at the edge of the pit 24 such that the handling device and the storage and/or charging zone 23 are arranged outside the pit 24, further limiting the general space required for the battery exchange solution.

From reading the above, it is clear that a battery exchange process allowed by the installing and uninstalling device is such that it comprises a step of moving the assembly, consisting of the lift table and the member engaging with the vehicle, in at least one substantially horizontal direction of movement. In the case where the direction of movement X of the assembly is perpendicular to the track 21, the direction X is substantially perpendicular to the longitudinal axis of the vehicle on which the battery is exchanged when parked in the installing/uninstalling zone 20. However, depending on the needs and possibilities for arranging the various constituent elements of the station, in particular with regard to the choice of location of the storage and/or charging zone relative to the installing and uninstalling zone, it remains possible that the direction of movement X of the assembly is substantially parallel with the longitudinal axis of the vehicle.

In the description above and with reference to FIG. 3, the positioning and/or position correction element may include two positioners 25 offset laterally on either side of the housing cell, perpendicular to the axis of the track 21, wherein each of the positioners 25 may for example take the form of a rod, the upper free end of which is adapted to cooperate with complementary elements carried by the vehicle in order to compensate, within a given range, for horizontal offsets between the table 11 and the vehicle 19 which could occur because of imprecise positioning of the vehicle. In addition, the position correction elements may comprise for example two front and rear supports 26, offset longitudinally parallel to the axis of the track 21. In FIG. 3, only the positioner 25 arranged on the left of table 21 is visible, the positioner arranged to the right being hidden by the front support 26. Each of the supports 26 can also take the form of a rod, the upper free end of which is designed to rest against the underside of the vehicle. The vehicle support function of the left positioner 25 is combined with the support of the vehicle by the supports 26 arranged on the right, so as to form a carrier with at least three feet, the vertical actuation of which by the movement of the table 11 in the direction Z ensures a position correction of the vehicle. These elements 25 and 26 can be mounted on the lift table in a removable manner as required.

Finally the solution described achieves the object desired and has the following advantages:
easy management of the diversity of batteries in exchange stations,
ensured observation of the integrity of each battery throughout the exchange cycle,
simple and straightforward operation,
possible standardization of handling interfaces,
possibility of loading different actuator elements 18 as a function of different battery types and/or locking mechanism types, giving great flexibility.

1-7. (canceled)

8. A device for installing and uninstalling a battery on an underside of an electric or hybrid vehicle, the underside of the vehicle lying in a first substantially horizontal plane, the device comprising:
a lift table which vertically moves an engaging member configured to interact with the underside of the vehicle, the engaging member being brought by the lift table into mechanical contact with the underside of the vehicle, a top of the engaging member then lying in a second substantially horizontal plane in a state that does not allow the engaging member to interact with the underside of the vehicle because of a relative inclination between the first and second planes,
wherein the lift table is raised by at least two cables, elasticity of the at least two cables allowing compensation for the relative inclination of the two planes to enable the engaging member to interact with the underside of the vehicle.

9. The device as claimed in claim 8, wherein the elasticity of the at least two cables allows compensation for the relative inclination of the two planes within a limit of deformability of the at least two cables.

10. The device as claimed in claim 8, wherein the at least two cables are arranged symmetrically on either side of the lift table.

11. The device as claimed in claim 8, wherein the at least two cables are driven by a same motor.

12. The device as claimed in claim 8, wherein the at least two cables are driven via pulleys.

13. The device as claimed in claim 8, further comprising a position correction element allowing the vehicle to be placed in the first substantially horizontal plane.

14. The device as claimed in claim 8, wherein the engaging member comprises an actuator element for a mechanism for locking and/or unlocking the battery on the underside of the vehicle, and the mechanism comprises a plurality of latches, and the elasticity of the at least two cables allows compensation for the relative inclination of the two planes to enable actuation of the latches.
